(19) United States
(12) Patent Application Publication
(10) Pub. No.: US 2008/0186932 A1
(43) Pub. Date: Aug. 7, 2008

(54) Approach For Mitigating The Effects Of Rogue Wireless Access Points

(76) Inventors: Duy Khuong Do, Melbourne (AU); Michael Clark Gibson, Austin, TX (US); Charles Arthur Willman, Austin, TX (US); Nestor Alexis Fesas, Austin, TX (US); Efstratios Skafidas, Thornbury (AU)

Correspondence Address: HICKMAN PALERMO TRUONG & BECKER, LLP, SUITE 550, 2055 GATEWAY PLACE, SAN JOSE, CA, 95110, US

(21) Appl. No.: 12/026,520

(22) Filed: Feb. 5, 2008

Related U.S. Application Data
(60) Provisional application No. 60/899,697, filed on Feb. 5, 2007.

(51) Int. Cl. H04Q 7/24

(52) U.S. Cl. 370/338

(57) ABSTRACT

According to an approach for mitigating the effects of rogue WAPs in wireless local area networks, a determination is made of one or more clients that are communicating with a rogue WAP. For example, messages may be intercepted and examined to identify messages that are sent by or to rogue WAPs. Information that identifies the one or more clients is then extracted from the messages and stored in a client list. Communications between the one or more clients and the rogue WAP are then disrupted. Embodiments of the invention include, without limitation, disrupting communications using deauthentication and by spoofing Address Resolution Protocol (ARP) responses.

### RELATED APPLICATION DATA AND CLAIM OF PRIORITY

This application claims the benefit of, and priority to, U.S. Provisional Patent Application No. 60/899,697, entitled Method and Apparatus for Mitigating Rogue Access Points in Wireless Local Area Networks, filed Feb. 5, 2007, the contents of which are incorporated by reference for all purposes as if fully set forth herein.

### FIELD OF THE INVENTION

This invention relates generally to wireless networking.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

Wireless Area Networks (WLANs) have grown in popularity because of the availability of low cost equipment and ease of installation and use. One of the issues with WLANs is the existence of so called “rogue” Wireless Access Points (WAPs). A rogue WAP generally is a WAP that has been installed in, or otherwise exists in, a network without explicit authorization from a network administrator. For example, a third party may use an unauthorized WAP to gain access to a network or to conduct a man-in-the-middle attack.

To prevent the installation of rogue WAPs, large organizations sometimes install wireless intrusion detection systems to monitor radio spectrum for unauthorized WAPs. Once an unauthorized, i.e., rogue, WAP has been detected, administrative personnel intervene and take some action to nullify the effects of the rogue WAP. For example, an administrator may determine a port to which the rogue WAP is connected and disable that port, or determine the location of the rogue WAP and disconnect it from the network. One problem with this approach is that until administrative personnel are alerted to the existence of a rogue WAP, the rogue WAP may provide service to clients, thereby gaining unauthorized access to network resources. Hence, an approach for automatically mitigating the effects of rogue WAPs without requiring human action is highly desirable.

### BRIEF DESCRIPTION OF THE DRAWINGS

In the figures of the accompanying drawings like reference numerals refer to similar elements.

FIG. 1 is a flow diagram that depicts an approach for mitigating the effects of rogue WAPs in wireless networks according to one embodiment of the invention.

FIG. 2A is a block diagram of an arrangement for mitigating the effects of rogue WAPs in WLANs.

FIG. 2B is a block diagram that depicts an example embodiment of the rogue WAP mitigation module that includes a monitoring module and a disruption module.

FIG. 3 is a block diagram that depicts an example implementation of a client list in the form of a linked list.

FIG. 4 is a flow diagram that depicts and approach for processing messages transmitted over a wireless local area network to determine whether a client is communicating with a rogue WAP, according to one embodiment of the invention.

FIG. 5 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:
I. Overview
II. Architecture for Mitigating the Effects of Rogue WAPs in WLANs
III. Discovering Clients Communicating with Rogue WAPSs
   A. Determining Client Communications With Rogue WAPs
   B. Maintaining the Client List
IV. Disrupting Communications Between Clients and Rogue WAPs using Deauthentication
   A. Deauthentication Messages
   B. Broadcast and Unicast
   C. Timing of Deauthentication messages
V. Disrupting Communications Between Clients and Rogue WAPs by Spoofing ARP Responses
VI. Implementation Mechanisms and Extensions

### I. Overview

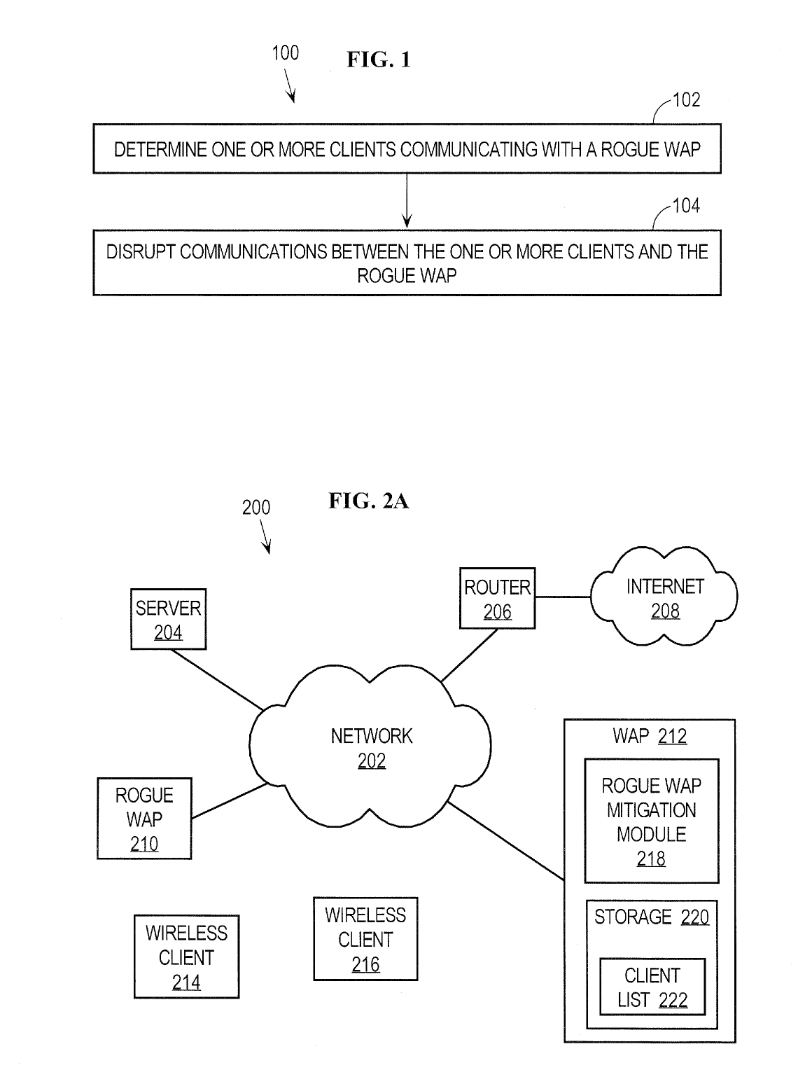

FIG. 1 is a flow diagram 100 that depicts an approach for mitigating the effects of rogue WAPs in wireless local area networks (WLANs) according to one embodiment of the invention. In step 102, a determination is made of one or more clients that are communicating with a rogue WAP. Determining one or more clients that are communicating with a rogue WAP may be performed using a wide variety of approaches, as described hereinafter. According to one embodiment of the invention, this determination is made by intercepting and examining messages communicated between clients and WAPs to identify messages that are sent by or to rogue WAPs. Information that identifies the one or more clients is then extracted from the messages and stored in a client list. In step 104, communications between the one or more clients and the rogue WAP are disrupted. Embodiments of the invention include, without limitation, disrupting communications using deauthentication and by spoofing Address Resolution Protocol (ARP) responses.

The approach described herein is very useful in protecting a network from unauthorized wireless access by disrupting the operation of unauthorized WAPs on the network while not interfering with normal traffic flow with authorized WAPs in the network.

II. Architecture for mitigating the Effects of Rogue WAPs in WLANs

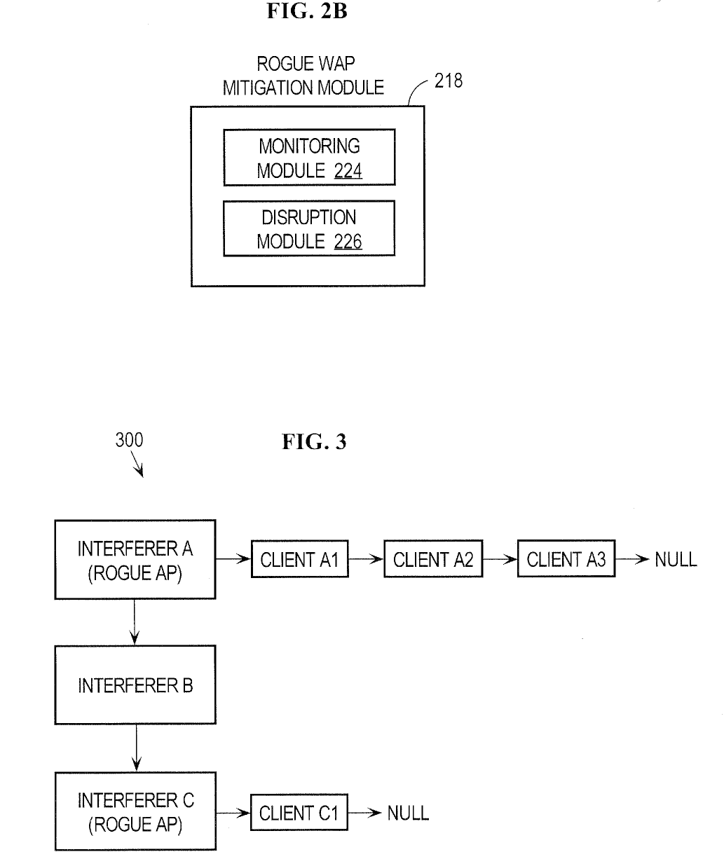

FIG. 2A is a block diagram that depicts an arrangement 200 for mitigating the effects of rogue WAPs in WLANs. Arrangement 200 includes a network 202 that provides for the exchange of information between a server 204, a router 206 that provides access to another network, such as the Internet 208, a rogue WAP 210 and a WAP 212. Network 202 may be any type of network, for example a LAN, a WAN or multiple networks. Server 204 may be any type of server, such as a Web server or a corporate server that makes information available to devices that have access to network 202, such as wireless clients 214, 216. Rogue WAP 210 is a WAP that is connected to network 202 but that is not authorized to access network 202. WAP 212 provides wireless access to network 202, for example to wireless clients 214, 216. Wireless clients 214, 216 may be any entity that is to participate in wireless communications. For example, wireless clients 214, 216 may be processes executing on devices or may be wireless devices, such as mobile devices. Thus, multiple wireless clients may exist on a single device.

WAP 212 includes a rogue WAP mitigation module 218 that is configured to implement the approach described herein for mitigating the effects of rogue WAPs in WLANs. WAP 212 also includes storage 220 for storing, for example, configuration data and data used by WAP mitigation module 218. For example, storage 220 may include a client list 222 generated and maintained by WAP mitigation module 218, as described in more detail hereinafter. Storage 220 may include any type of volatile or non-volatile storage, or any combination thereof. WAP 212 may include other elements not depicted in the figures or described herein for purposes of brevity. For example, WAPs conventionally include an antenna arrangement, a wireless interface, a wired interface and a microprocessor and other circuitry to enable wireless communications.

As depicted in FIG. 2B, one embodiment of the rogue WAP mitigation module 218 includes a monitoring module 224 for monitoring communications channels and discovering clients communicating with rogue WAPs. Rogue WAP mitigation module 218 also includes a disruption module configured to disrupt communications between clients and rogue WAPs. The rogue WAP mitigation module 218 and its constituent monitoring module 224 and disruption module 226 may be implemented in computer hardware, computer software, or any combination of computer hardware and software. Furthermore, functionality of these elements may be implemented on other network elements besides WAP 212, for example on server 204, router 206, clients 214, 216, other network elements, or combinations of network elements. Arrangement 200 may include other elements, depending upon a particular implementation, that are not depicted in FIG. 2A or described herein for purposes of brevity.

III. Discovering Clients Communicating with Rogue WAPSs

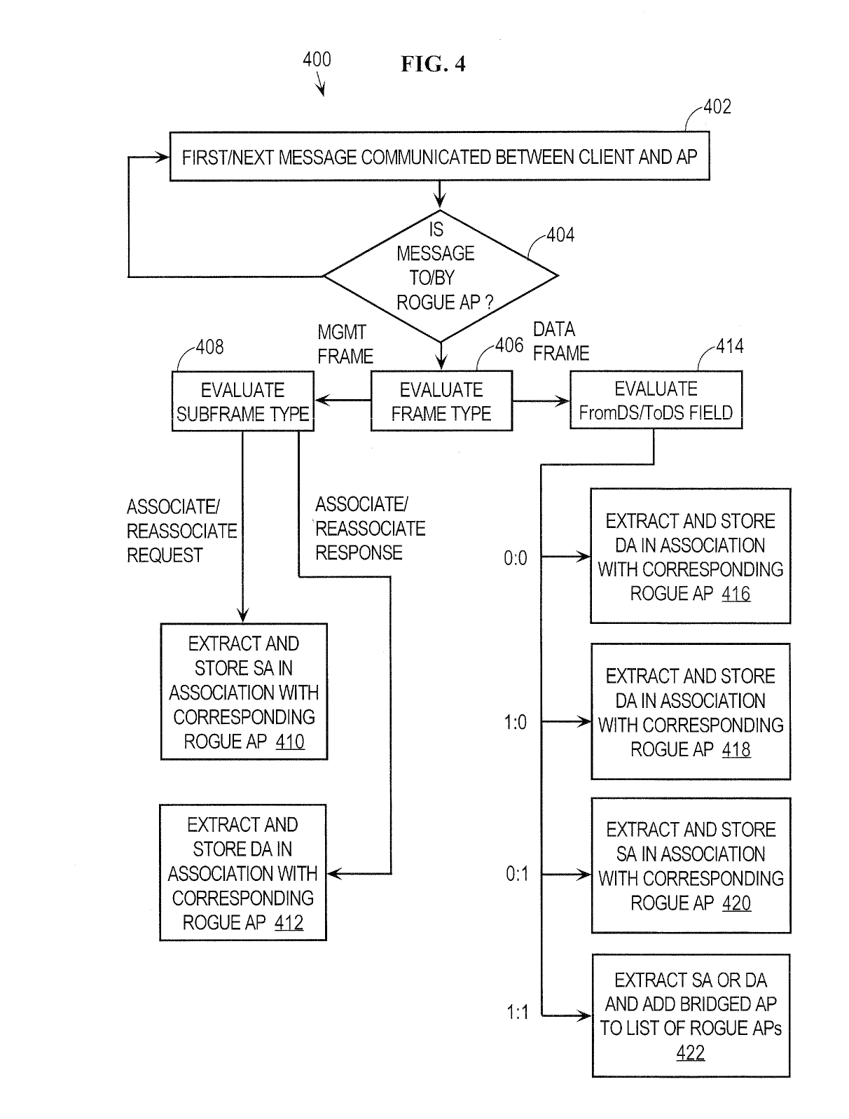

According to one embodiment of the invention, WAP mitigation module 218 is configured to discover, i.e., determine one or more clients that are communicating with rogue WAPs. This generally involves listening to wireless communications traffic and looking for messages that are being sent to or sent by a rogue WAP. For example, in the context of 802.11 communications, this is performed by examining the basic service set identifier (BSSID) field of messages and comparing the BSSID of messages to BSSIDs of rogue WAPs. If a message contains a BSSID of a rogue WAP, then additional information about the client involved in the communication is extracted from the message and stored. For example, the MAC address of a client device stored in the sending address (SA) or destination address (DA) field is stored in association with the rogue WAP, as described in more detail hereinafter. According to one embodiment of the invention, WAP mitigation module 218 generates and maintains client list 222 that includes data that identifies or corresponds to client devices determined to be communicating with rogue WAPs. Client list 222 may be maintained in any type of data structure and contain a wide variety of information, that may vary depending upon a particular implementation. FIG. 3 is a block diagram depicting one example implementation of client list 222 in the form of a linked list 300. In this example, linked list 300 that includes three interferers, i.e., WAPs, identified in FIG. 3 as Interferer A, Interferer B and Interferer C. Interferers A and C are known to be rogue WAPs and Interferer B is not a rogue WAP, i.e., is an authorized WAP. Interferer A includes a link to a linked list of three entries that correspond to clients A1, A2 and A3 that are determined to be communicating with Interferer A. Each of these entries contains information that identifies the corresponding client. For example, the entry for client A1 includes the MAC address of client A1.

### A. Determining Client Communications With Rogue WAPs

FIG. 4 is a flow diagram 400 that depicts an approach for processing messages transmitted over a wireless local area network to determine whether a client is communicating with a rogue WAP, according to one embodiment of the invention. The process starts in step 402 when a first/next message is communicated between a client and a WAP. In step 404, a determination is made whether the message is transmitted to or by a rogue WAP. This may be determined, for example, by examining the contents of the BSSID field in the message and comparing the BSSID value in the message to one or more other BSSID values. For example, the BSSID value from the message may be compared to a list of BSSID values that correspond to authorized WAPs. If the BSSID value does not match the BSSID values of any of the known authorized WAPs, then the message may have been sent by, or to, a rogue WAP. As another example, the BSSID may be compared to a list of known rogue WAPs. If, in step 404, the BSSID extracted from the message does not correspond to a rogue WAP, then the next message is evaluated in step 402.

If, in step 404, the BSSID does correspond to a rogue WAP, then in step 406, the frame type of the message is evaluated, for example, by examining one or more fields of the message. If the frame type indicates the message corresponds to a management frame, then in step 408, the subframe type is examined to determine whether the frame is an associate/reassociate request or an associate/reassociate response. If the subframe type indicates that the frame is an associate/reassociate request, then the message originated from a client and was being transmitted to the rogue WAP. In this situation, in step 410, the sending address (SA) is extracted and stored in client list 222 in association with the corresponding rogue WAP. If, in step 408, the subframe type indicates that the frame is an associate/reassociate response, then the message originated from a rogue WAP and was being transmitted to a client. In step 412, the destination address (DA) is extracted and stored in client list 222 in association with the corresponding rogue WAP.

If, in step 406, the frame type indicates the message corresponds to a data frame, then in step 414, the FromDS/ToDS frame control field is examined to determine the participants in the communication. If the FromDS/ToDS frame control field contains a value of “0:0”, then the message corresponds to a control frame that originated at the rogue WAP and in step 416, the destination address (DA) is extracted from the message and stored in client list 222 in association with the corresponding rogue WAP. If the FromDS/ToDS frame control field contains a value of “1:0”, then the message originated at the rogue WAP and in step 418, the destination address (DA) is extracted from the message and stored in client list 222 in association with the corresponding rogue WAP. If the FromDS/ToDS frame control field contains a value of “0:1”, then the message originated at a client communicating with the rogue WAP and in step 420, the source address (SA) is extracted from the message and stored in client list 222 in association with the corresponding rogue WAP. If the FromDS/ToDS frame control field contains a value of “1:1”, then the message was being transmitted between WAPs attempting to bridge and exchange information. In this situation, in step 422, depending upon the direction of the frame, either the SA, or DA, is extracted from the message, and the bridged WAP is added to the list of rogue WAPs.

### B. Maintaining the Client List

Wireless communications environments are often dynamic, especially when clients are mobile devices. In some situations, clients cease communicating with rogue WAPs. This may occur for a wide variety of reasons. For example, a client may be currently communicating with authorized, i.e., non-rogue, WAPs. As another example, a client may be a mobile client that moves out of range of rogue WAPs. As yet another example, a client may have been turned off or is otherwise no longer communicating with any WAPs. According to one embodiment of the invention, rogue WAP mitigation module 218 is configured to maintain the client list 222 by removing clients that are no longer active. Various “pruning” techniques may be used to maintain the client list 222 and the invention is not limited to any particular pruning technique. One example technique is to remove clients that are not communicating with rogue WAPs for at least a threshold number of checks. For example, a counter may be maintained for each client that indicates the number of consecutive times that the corresponding client has not been determined to be communicating with a rogue WAP. If the counter exceeds a threshold, then the client is removed from client list 122.

IV. Disrupting Communications Between Clients and Rogue WAPs using Deauthentication

### A. Deauthentication Messages

Once a determination has been made of clients that are communicating with rogue WAPs, then communications are disrupted between those clients and the rogue WAPs. According to one embodiment, clients are deauthenticated from rogue WAPs. This is accomplished by generating and transmitting deauthentication messages that cause the clients and rogue WAPs to be deauthenticated. Causing clients and rogue WAPs to change to a deauthenticated state disrupts the communications sessions and the clients and WAPs must reauthenticate and reassociate to resume communications.

The deauthentication messages are generated based upon the information about the clients obtained during the discovery phase and information about the rogue WAPs. The deauthentication messages may be from the perspective of the client devices, the rogue WAPs, or both the client devices and the rogue WAPs. For example, from the perspective of a client device in the context of 802.11 communications, a deauthentication notification is generated and transmitted that includes a sending address, e.g., MAC address, of one of the client devices determined to be communicating with the rogue WAP, a destination address, e.g., MAC address, of the rogue WAP and the BSSID of the rogue WAP. According to one embodiment of the invention the reason code in the deauthentication notification is set to “unspecified reason”, although other codes may also be used. For example, the “Deauthenticated because sending station is leaving (or has left) IBSS or ESS” reason may also be used. From the perspective of the rogue WAP, this message is a valid deauthentication notification sent by a particular client device and causes the session between the WAP and the particular client device to be disrupted.

As another example, from the perspective of a rogue WAP in the context of 802.11 communications, a deauthentication notification is generated and transmitted that includes the sending address of the rogue WAP, the destination address of one of the clients determined to be communicating with the rogue WAP and the BSSID of the rogue WAP. From the perspective of the recipient client, this message is a valid deauthentication notification sent by the rogue WAP and causes the recipient client to be deauthenticated. Both types of deauthentication messages may be used, i.e., both from the perspective of a client and from the perspective of a rogue WAP. Note that in some situations, one type of message may be more effective than the other. For example, suppose that wireless client 214 is within range of rogue WAP 210, but out of range of WAP 212. In this situation, transmitting a deauthentication notification from the perspective of wireless client 214 as the sender and rogue WAP 210 as the recipient would be more effective, since rogue WAP 210 will receive and process the message, presuming that rogue WAP 210 is in range of WAP 212. In this situation, sending a deauthentication message sent from the perspective of rogue WAP 210 would not be effective because wireless client 214 is out of range of WAP 212 and therefore wireless client 214 would not receive the message.

### B. Broadcast and Unicast

Deauthentication messages may be transmitted as broadcast or unicast messages, i.e., with a broadcast or unicast address. The 802.11 standard does not prohibit the use of broadcast messages and broadcast messages have several benefits. For example, broadcast messages provide the benefit of deauthenticating multiple clients in a single request. This includes clients, such as so called “hidden clients” that have not yet been discovered communicating with a rogue WAP. Disrupting communications of hidden clients is beneficial because hidden clients consume network bandwidth and reduce performance for “authenticated” and legitimate clients. For a broadcast deauthentication message, the value of the DA field is set to the broadcast address and the values of the SA and BSSID fields are set to MAC address of rogue WAP. One drawback of broadcast messages is that not all clients may honor or act on broadcast messages, depending upon a particular implementation. Thus, broadcast messages may not disrupt all clients communicating with a rogue WAP. Unicast messages do not have this limitation, but may require more messages be generated and transmitted to achieve the same result as using a broadcast message and thus place a higher load on a wireless communications system. Therefore, the deauthentication messages may be generated and transmitted as broadcast messages, unicast messages, or a combination of broadcast and unicast messages, depending upon a particular implementation.

### C. Timing of Deauthentication Messages

Deauthentication messages may be transmitted at different times, depending upon a particular implementation. For example, according to one embodiment of the invention, discovery is performed on a complete set of communications channels and then disruption is performed based upon the results of the discovery, as previously described herein. Depending upon the number of communications channels that need to be evaluated and other factors, such as how quickly the rogue WAP mitigation module 218 can perform its discovery, the time required to evaluate all the channels may be sufficiently long to allow clients and rogue WAPs to reestablish communications, e.g., by completing a new authentication and association process. Therefore, according to another embodiment of the invention, deauthentication messages may be transmitted on a channel-by-channel basis after each channel is evaluated. This reduces the time between determining that clients are communicating with a rogue WAP and the transmission of deauthentication messages. According to another embodiment of the invention, as soon as a client is identified that is communicating with a rogue WAP, one or more deauthentication messages are generated and transmitted. This approach further reduces the amount of time between detecting that a client is communicating with a rogue WAP and transmitting one or more deauthentication messages to disrupt communications between the client and the rogue WAP. Deauthentication messages may also be re-transmitted any number of times to prevent clients and WAPs from reestablishing communications sessions.

### V. Disrupting Communications Between Clients and Rogue WAPs by Spoofing ARP Responses

Disrupting communications between clients and rogue WAPs may also be accomplished by spoofing ARP responses to provide incorrect information to clients and delay reconnection to a rogue WAP. For example, according to one embodiment of the invention, after a client generates and transmits an ARP request to discover the hardware MAC address of a node on the network or a WAP, the rogue WAP mitigation module 218 responds to that client with a “spoofed” ARP response.

According to one embodiment of the invention, a client generates and broadcasts an ARP request into the network. The rogue WAP mitigation module 218 receives the ARP request, and determines whether the sent ARP request was an attempt to communicate with a rogue WAP. For example, at the layer 3 of the multi-layer network protocol, specifically at the IP layer, the MAC address of the source of the ARP request may be compared with MAC addresses contained in the client list 300. If the source address of the ARP request matches one of the addresses contained in the client list 300, then the client is currently communicating with a rogue WAP. Alternatively, this may also be determined by reading the destination address from the ARP “response,” and by comparing the destination address to the addresses of known “clients associated with known rogue WAPs.” If the destination address matches the address of a “client associated with known rogue WAP,” then the client is currently communicating with a rogue WAP.

If a determination is made that the ARP request was sent from a rogue client, i.e. a client accessing the network through a rogue WAP, the rogue WAP mitigation module 218 generates and transmits an ARP response to the client. The ARP response contains a MAC address other than the MAC address sought by the client communicating through the rogue WAP. For example, the MAC address of WAP 212 or a random MAC address may be used instead of the MAC address of the rogue WAP. This causes destination address of packets sent from the client to the computer on the network to be incorrect and prevents the packets from reaching correct computer on the network. By spoofing ARP responses this way, the ARP cache of the client connected to the rogue WAP is populated with erroneous entries, thus preventing the client from communicating with its intended recipient.

The approach described herein for disrupting communications between clients and rogue WAPs may be used separate from or in combination with the other disruption approaches described herein.

### VI. Implementation Mechanisms and Extensions

Although the approach for mitigating the effects of rogue WAPs has been described herein primarily in the context of disrupting communications by causing deauthentication of clients and WAPs, other approaches may be used. For example, messages may be generated and transmitted to a rogue WAP that have an (intentionally) incorrect length set in the header so that the rogue WAP hangs for some time. As another example, messages may be generated and transmitted to a rogue WAP to spoof Ethernet packets (perhaps an XID packet) with the DA set to the rogue WAP and the SA set to a client. This may cause the bridge function in the rogue WAP to get confused. It may also cause the Ethernet switch network to temporarily switch packets intended for the client to the WAP where the rogue WAP mitigation module resides instead of the rogue WAP. Another approach is to actively jam all packets transmitted from the rogue WAP by having the MAC FW transmit a packet with the intent to cause a collision. Yet another approach is to spoof wireless data packets from WAP to a client that purposefully contain CRC errors in hope it will cause the client to scan for a new WAP.

Although the approach has been described herein primarily in the context of mitigating the effects of rogue WAPs, the approach is applicable to other contexts as well. For example, the approach may be used to mitigate the effects of rogue clients. Suppose that one or more communications are detected between an unauthorized client and one or more WAPs. Suppose further that the WAPs are authorized WAPs. The approach described herein may be used to disrupt communications between the unauthorized client and any other device, including other clients or WAPs. For example, one or more unicast messages may be sent to the unauthorized client to cause the unauthorized client to be deauthenticated.

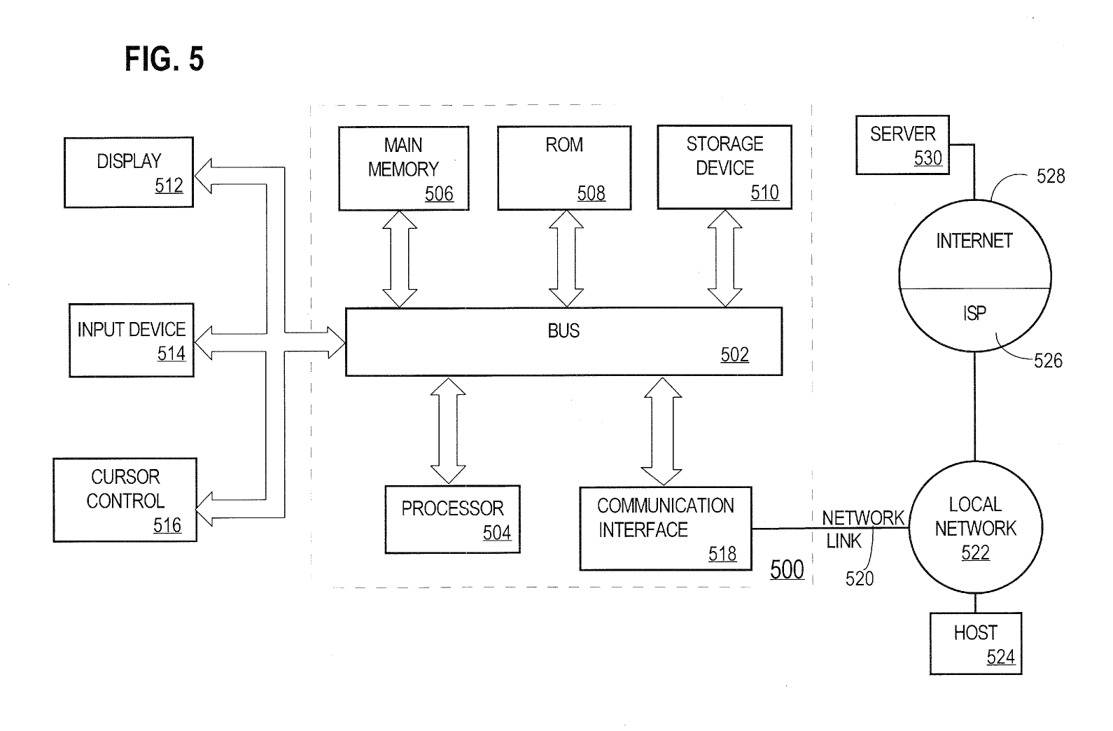

The approach described herein for mitigating the effects of rogue WAPs may be implemented on any type of computing architecture and computing platform, depending upon a particular implementation, and the invention is not limited to any particular type of computing architecture or computing platform. For purposes of explanation, FIG. 5 is a block diagram that depicts an example computer system 500 upon which embodiments of the invention may be implemented. Computer system 500 includes a bus 502 or other communications mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a computer to operation in a specific manner. In an embodiment implemented using computer system 500, various computer-readable media are involved, for example, in providing instructions to processor 504 for execution. Such a medium may take many forms, including but not limited to, non-volatile media and volatile media. Non-volatile media includes, for example, optical or magnetic disks, such as storage device 510. Volatile media includes dynamic memory, such as main memory 506. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communications interface 518 coupled to bus 502. Communications interface 518 provides a two-way data communications coupling to a network link 520 that is connected to a local network 522. For example, communications interface 518 may be an integrated services digital network (ISDN) card or a modem to provide a data communications connection to a corresponding type of telephone line. As another example, communications interface 518 may be a local area network (LAN) card to provide a data communications connection to a compatible LAN. Wireless links may also be implemented. In any such implementation, communications interface 518 sends and receives electrical, electromagnetic or optical signals that carry digital data streams representing various types of information.

Network link 520 typically provides data communications through one or more networks to other data devices. For example, network link 520 may provide a connection through local network 522 to a host computer 524 or to data equipment operated by an Internet Service Provider (ISP) 526. ISP 526 in turn provides data communications services through the world wide packet data communications network now commonly referred to as the “Internet” 528. Local network 522 and Internet 528 both use electrical, electromagnetic or optical signals that carry digital data streams.

Computer system 500 can send messages and receive data, including program code, through the network(s), network link 520 and communications interface 518. In the Internet example, a server 530 might transmit a requested code for an application program through Internet 528, ISP 526, local network 522 and communications interface 518. The received code may be executed by processor 504 as it is received, and/or stored in storage device 510, or other non-volatile storage for later execution.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for mitigating the effects of rogue wireless access points (WAPs) in a wireless local area network, the computer-implemented method comprising:
determining one or more clients communicating with a rogue WAP; and
disrupting communications between the one or more clients and the rogue WAP.

2. The computer-implemented method of claim 1, wherein the determining one or more clients communicating with a rogue WAP further comprises:
monitoring one or more communications channels that carry communications data between WAPs and clients;
monitoring one or more communications channels that carry communications data between a node in the wireless local area network and a client accessing the wireless local area network via the rogue WAP;
receiving data exchanged between the rogue WAP and the client;
receiving data exchanged between the client accessing the wireless local area network via the rogue WAP and the node in the wireless local area network;
extracting address information from the received data; and
determining that the address information corresponds to the rogue WAP.

3. The computer-implemented method of claim 2, wherein the disrupting communications between the one or more clients and the rogue WAP is performed in response to receiving the data exchanged between the rogue WAP and the client.

4. The computer-implemented method of claim 2, wherein the extracting address information from the received data further comprises determining a BSSID field, an SA field, a DA field and a data field in the address information.

5. The computer-implemented method of claim 2, further comprising:
determining whether the received data represents a management frame;
if the received data represents a management frame, then:
determining whether the management frame corresponds to an associate or reassociate request,
if the management frame corresponds to the associate or reassociate request, then:
extracting an SA value from an SA field in the received data, and
storing the SA value in association with the rogue WAP,
determining whether the management frame corresponds to an associate or reassociate response,
if the management frame corresponds to the associate or reassociate response, then:
extracting an DA value from a DA field in the received data, and
storing the DA value in association with the rogue WAP.

6. The computer-implemented method of claim 2, further comprising:
determining whether the received data represents a data frame;
if the received frame is the data frame, then:
determining whether the address information in the data frame contains an SA field,
if the address information in the data frame contains the SA field, then:
extracting an SA value from the SA field, and
storing the SA value in association with the rogue WAP,
determining whether the address information in the data frame contains an DA field,
if the address information in the data frame contains the DA field, then:
extracting an DA value from the DA field, and
storing the DA value in association with the rogue WAP.

7. The computer-implemented method of claim 1, wherein the disrupting communications between the one or more clients and the rogue WAP further comprises generating and transmitting a deauthentication message to cause at least one client from the one or more clients to be deauthenticated.

8. The computer-implemented method of claim 1, wherein the disrupting communications between the one or more clients and the rogue WAP further comprises periodically transmitting a deauthentication message to cause at least one client from the one or more clients to be periodically deauthenticated.

9. The computer-implemented method of claim 1, wherein the disrupting communications between the one or more clients and the rogue WAP further comprises generating and transmitting a unicast deauthentication message having a sending address that corresponds to the rogue WAP and a destination address that corresponds to at least one client from the one or more clients.

10. The computer-implemented method of claim 1, wherein the disrupting communications between the one or more clients and the rogue WAP further comprises generating and transmitting a broadcast deauthentication message having a sending address that corresponds to the rogue WAP.

11. The computer-implemented method of claim 1, wherein the disrupting communications between the one or more clients and the rogue WAP further comprises generating and transmitting a unicast deauthentication message having a sending address that corresponds to a particular client from the one or more clients and a destination address that corresponds to the rogue WAP.

12. The computer-implemented method of claim 1, wherein the disrupting communications between the one or more clients and the rogue WAP further comprises generating a transmitting a unicast deauthentication message having a sending address that corresponds to a particular client from the one or more clients and a destination address that corresponds to the rogue WAP.

13. The computer-implemented method of claim 1, wherein disrupting communications between the one or more clients and the rogue WAP includes generating and transmitting to the rogue WAP one or more messages containing incorrect length values.

14. The computer-implemented method of claim 1, wherein disrupting communications between the one or more clients and the rogue WAP includes generating and transmitting to the rogue WAP one or more messages containing CRC errors.

15. The computer-implemented method of claim 1, wherein disrupting communications between the one or more clients and the rogue WAP includes generating and transmitting to the rogue WAP one or more Ethernet packets containing errors in a destination address or a source address.

16. The computer-implemented method of claim 1, further comprising:
intercepting an ARP request sent by a client accessing the network via the rogue WAP; and
generating and transmitting to the client an ARP response in reply to the ARP request, wherein the ARP response contains a MAC address value that is not the MAC address corresponding to the destination IP address contained in the ARP request.

17. A computer-readable medium for mitigating the effects of rogue wireless access points (WAPs) in a wireless local area network, the computer-readable medium carrying instructions which, when executed by one or more processors, cause:
determining one or more clients communicating with a rogue WAP; and
disrupting communications between the one or more clients and the rogue WAP.

18. An apparatus for mitigating the effects of rogue wireless access points (WAPs) in a wireless local area network, the apparatus comprising a memory storing instructions which, when executed by one or more processors, cause:
determining one or more clients communicating with a rogue WAP; and
disrupting communications between the one or more clients and the rogue WAP.

19. An apparatus for mitigating the effects of rogue wireless access points (WAPs) in a wireless local area network, the apparatus comprising:
means for determining one or more clients communicating with a rogue WAP; and
means for disrupting communications between the one or more clients and the rogue WAP.
